(19) United States
(12) Patent Application Publication
(10) Pub. No.: US 2010/0111072 A1
(43) Pub. Date: May 6, 2010

(54) Internet Phone Service System and Internet Phone Service Method by Using Softphone Created by Users

(76) Inventor: Jae-Bong Hyun, Goyang-si (KR)

Correspondence Address: HOFFMANN & BARON, LLP, 6900 JERICHO TURNPIKE, SYOSSET, NY, 11791, US

(21) Appl. No.: 12/532,858

(22) PCT Filed: Apr. 10, 2008
(86) PCT No.: PCT/KR2008/002022

§ 371 Date: Sep. 24, 2009

(30) Foreign Application Priority Data
Apr. 12, 2007 (KR) 10-2007-0035920

(51) Int. Cl. H04L 12/66

(52) U.S. Cl. 370/352

(57) ABSTRACT

Provided are an Internet phone service system and method by using softphone created by users. The Internet phone service system includes: a service system creating a softphone created by users based on information input through a webpage and connecting calls made over the Internet by using the softphone created by users; a creator requesting the creation of the softphone created by users by inputting the information to the service system and, after the softphone created by users is created, downloading the softphone created by users in the form of an execution file or inserting a universal resource locator (URL) code into a webpage as a link to the softphone created by users; a user using the softphone created by users in the form of the execution file in a personal computer (PC) environment or clicking on the URL code, which is inserted into the webpage, to make phone calls over the Internet.

### TECHNICAL FIELD

The present invention relates to an Internet phone service system and method by using softphone created by users, and more particularly, to an Internet phone service system and method by using softphone created by users, in which a creator can create a softphone created by users in the form of an execution file to easily transmit the softphone created by users charged with a predetermined amount of money to users and can insert various images and texts into the softphone created by users according to his or her taste.

### BACKGROUND ART

Recent years have witnessed the rapid development of information and communication technology (ICT), in particular, the Internet. As a result, computers all over the world are now connected to each other through the Internet, and a wide variety of services are being offered over the Internet. A primary example of such services is an Internet phone service.

The Internet phone service transmits voice data packets through the Internet by using voice-over-Internet protocol (VoIP) technology. Thus, users can make phone calls over the Internet as they do by using conventional phones. In addition, since the Internet phone service is less expensive than conventional wired and wireless phone services, it is attracting more users.

In the Internet phone service, calls are sent through an Internet network instead of a telephone line. With the development of voice processing technology and technology for linking the Internet network and a conventional telephone network, the Internet phone service is being applied to personal computer (PC)-to-PC, PC-to-wired/wireless phone, and wired/wireless phone-to-wired/wireless phone communications.

Generally, an Internet call sending/receiving unit is required to use the Internet phone service. Here, the Internet call sending/receiving unit may be a softphone which is installed on a PC in the form of software or a hardware phone, such as a conventional wired/wireless phone, which is installed on a hardware device. Since the present invention relates to a softphone which is provided in the form of software, the following description will focus on the softphone.

In order to make phone calls over the Internet by using a conventional softphone, a user has to download a softphone program provided by an Internet phone service system to his or her PC and install the downloaded softphone program on his or her PC. In addition, the user has to subscribe to the Internet phone service system. A conventional softphone program is produced as a PC application for Internet call connection. Thus, the conventional softphone program can be used after being installed on a PC.

However, the conventional softphone, which is produced as a PC application, has the following drawbacks. First, a user must install a softphone program on his or her PC and subscribe to an Internet phone service system in order to make phone calls over the Internet by using the conventional softphone. Therefore, those who intend to use the Internet phone service only once may find the above installation and subscription processes quite cumbersome and thus may avoid using the Internet phone service.

In the Internet phone service system using the conventional softphone, all service users have no choice but to use a standardized softphone provided by a service system. That is, it is fundamentally impossible for users to create softphones that suit their tastes.

Furthermore, in the Internet phone service system using the conventional softphone, users cannot make collect calls over the Internet.

### DETAILED DESCRIPTION OF THE INVENTION

### Technical Goal of the Invention

The present invention provides an Internet phone service system and method by using softphone created by users, in which a creator can easily and quickly create a softphone that suits his or her taste by inputting setting information (e.g., call setting information and the user interface (UI) setting information of the softphone) and can use or distribute the softphone in various Internet-enabled environments including PC and web browser environments.

The present invention also provides an Internet phone service system and method by using softphone created by users, in which a user can make collect calls over the Internet.

The present invention also provides an Internet phone service system and method by using softphone created by users, in which a user can use a softphone without going through a subscription process or a login process of entering an ID and a password.

### Disclosure of the Invention

According to an aspect of the present invention, there is provided an Internet phone service system by using softphone created by users. The Internet phone service system includes: a service system creating a softphone created by users based on information input through a webpage and connecting calls made over the Internet by using the softphone created by users; a creator requesting the creation of the softphone created by users by inputting the information to the service system and, after the softphone created by users is created, downloading the softphone created by users in the form of an execution file or inserting a universal resource locator (URL) code into a webpage as a link to the softphone created by users; a user using the softphone created by users in the form of the execution file in a personal computer (PC) environment or clicking on the URL code, which is inserted into the webpage, to make phone calls over the Internet.

The service system may include: a web server providing a creation webpage through which information required to create a softphone created by users is input and a management webpage which is used to modify a softphone created by users after being created and provides a URL code, which uses execution environment information of the softphone created by users as a resource, to enable the user to download the softphone created by users to the user's PC in the form of the execution file or to use the softphone created by users on a webpage; a generation service creating a softphone created by users based on the information input through the creation and management webpages; a database (DB) storing execution environment information required to configure and execute the softphone created by users; a storage server storing an execution file of the softphone created by users; and a telephony system supporting phone calls made over the Internet by using the softphone created by users.

The softphone created by users may include: a user interface (UI) display unit forming an external display of the softphone created by users; execution environment information including configuration and execution information of the softphone created by users; and a plug-in engine including a URL processing unit which calls and processes a URL that uses the execution environment information as a resource, a softphone stack module which connects a phone call over the Internet based on call information input through the UI display unit, and a platform which links the UI display unit to the softphone stack module.

According to another aspect of the present invention, there is provided an Internet phone service method by using softphone created by users. The method includes: a creator inputting information required to create a softphone created by users in the form of an execution file to a service system; the service system creating the softphone created by users based on the information input by the creator; the creator downloading the created softphone created by users in the form of the execution file or inserting a URL code into a webpage as a link to the created softphone created by users; and a user using the softphone created by users in a PC environment in the form of the execution file or clicks on the URL code, which is inserted into the webpage, to make phone calls over the Internet.

### BRIEF DESCRIPTION OF THE DRAWINGS

FIG. 1 is a block diagram of a softphone created by users according to the present invention;

FIG. 2 is a block diagram of an Internet phone service system for creating and modifying a softphone created by users according to the present invention;

FIGS. 3 and 4 are flowcharts respectively illustrating processes of creating and modifying a softphone created by users according to the present invention;

FIGS. 5 and 6 respectively show examples of the configuration of an external display of a softphone created by users that appears on a personal computer (PC) screen;

FIG. 7 is a block diagram of the Internet phone service system for obtaining and using a softphone created by users according to the present invention;

FIGS. 8 and 9 are flowcharts respectively illustrating processes of obtaining and using a softphone created by users according to the present invention;

FIGS. 10 and 11 are screens showing the process of obtaining a softphone created by users according to the present invention; and

FIG. 12 shows an example of a webpage into which a softphone created by users according to the present invention has been inserted.

### EXPLANATION OF REFERENCE NUMERALS DESIGNATING THE MAJOR ELEMENTS OF THE DRAWINGS

10: service system
11: web server
12, 22: webpage
13: generation server
14: storage server
15: database (DB)
16: plug-in download server
17: telephony system
20: web service system

### BEST MODE FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

Hereinafter, an Internet phone service system and method by using softphone created by users according to the present invention will be described with the attached drawings.

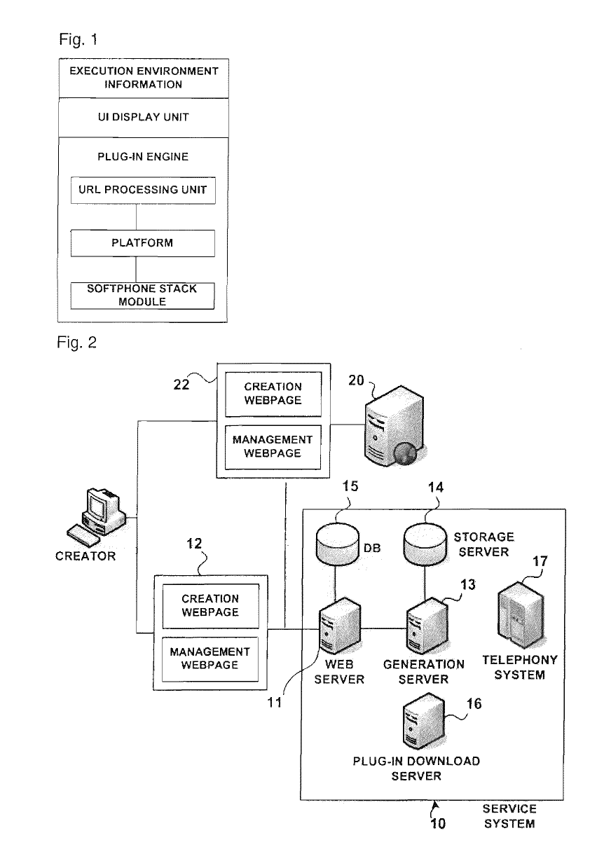

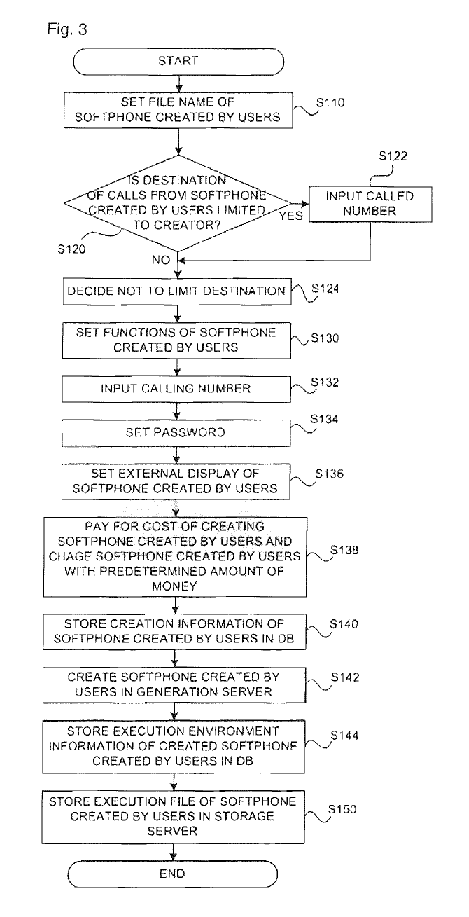

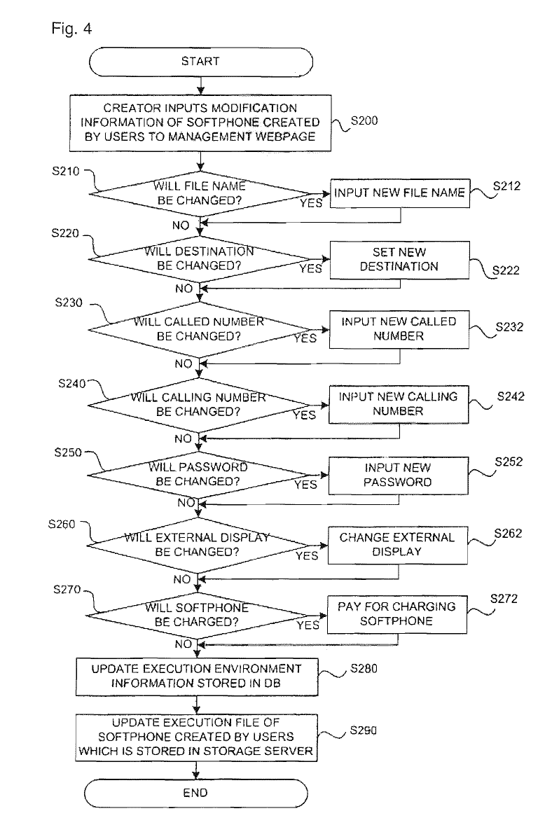

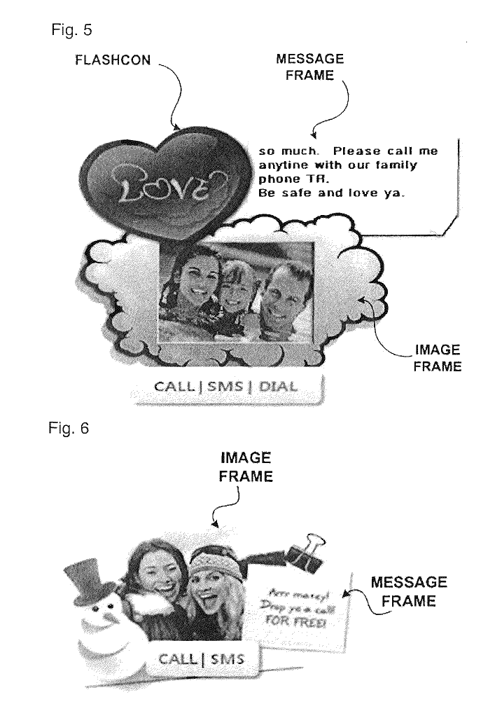

FIG. 1 is a block diagram of a softphone created by users according to the present invention. FIG. 2 is a block diagram of an Internet phone service system for creating and modifying a softphone created by users according to the present invention. FIGS. 3 and 4 are flowcharts respectively illustrating processes of creating and modifying a softphone created by users according to the present invention. FIGS. 5 and 6 respectively show examples of the configuration of an external display of a softphone created by users that appears on a personal computer (PC) screen.

A softphone created by users according to the present invention is a kind of softphone used to make phone calls over the Internet. Specifically, the softphone created by users according to the present invention is a softphone that can be created very easily and quickly by a service system 10 of FIG. 2 based on information input by a creator to the service system 10. Here, the softphone created by users is configured and designed according to the creator's taste. The softphone created by users created by the creator may be provided in the form of an execution file (e.g., an EXE file) or in the form of a universal resource locator (URL) code that contains conditions for executing the softphone created by users. When the softphone created by users is provided in the form of an execution file, the execution file may be transmitted to users through e-mails, messengers, and the like. When the softphone created by users is provided in the form of a URL code, the URL code may be inserted into all webpages and documents as a link to the softphone created by users. The softphone created by users may be configured such that it can be used in various Internet-enabled environments including PC and web browser environments. In addition, the softphone created by users may be configured such that it can be used by the creator or a plurality of users.

Referring to FIG. 1, the softphone created by users includes a user interface (UI) display unit, execution environment information, a URL processing unit, a softphone stack module, and a platform. The UI display unit forms an external display of the softphone created by users which is used to make phone calls or send short message service (SMS) messages in a web browser or PC environment. The execution environment information includes configuration and execution information of the softphone created by users as well as configuration information of the UI display unit. The URL processing unit calls and processes a URL indicating where the execution environment information exists. The softphone stack module connects a phone call over the Internet based on call information input through the UI display unit. The platform communicates with the UI display unit and the softphone stack module in order to link the UI display unit to the softphone stack module.

Specifically, the UI display unit provides all components of the external display of the softphone created by users that appears on a PC screen. The UI display unit may be formed as a flash so that the external display of the softphone created by users includes various components such as diverse static and dynamic images, animation effects, music, moving images, and the like.

The softphone stack module which connects a phone call over the Internet is configured the same as a unit for connecting a phone call over the Internet which is included in a conventional softphone. However, while the unit for connecting a phone call over the Internet and a UI which forms an external display image of the conventional softphone are integrated with each other and cannot be separated, the UI display unit and the softphone stack module of the softphone created by users according to the present invention are manufactured and operated separately. For this reason, the softphone created by users according to the present invention further includes the platform to link the UI display unit to the softphone stack module.

The execution environment information includes various information input by the creator to create the softphone created by users and various information which is set when the service system 10 creates the softphone created by users based on the information input by the creator. That is, the execution environment information includes all information required to configure and execute the softphone created by users. For example, the information input by the creator to create the softphone created by users may include calling and called numbers of the softphone created by users, a password required to use the softphone created by users, and various information which forms the external display of the softphone created by users. In addition, the information set when the service system 10 creates the softphone created by users may include user login information, user verification information required to use an Internet phone service, such as a personal identification number (PIN), and the ID and version information of the softphone created by users. The execution environment information may vary according to softphone created by users and can be modified after the softphone created by users is created.

The URL processing unit calls a URL indicating where the execution environment information is stored from the service system 10 and processes the URL. That is, when a user clicks on the softphone created by users according to the present invention, the URL processing unit calls and processes the execution environment information of the softphone created by users, thereby executing the softphone created by users.

The execution environment information and the UI display unit described above may be configured differently in each softphone created by users, whereas the URL processing unit, the platform and the softphone stack module are configured and operated the same in all softphone created by users. Therefore, in the present invention, the URL processing unit, the platform and the softphone stack module, which are configured the same in all softphone created by users, are integrated into a single module, and the single module is defined as a plug-in engine. In this regard, the softphone created by users according to the present invention includes the execution environment information, the UI display unit, and the plug-in engine.

In the Internet phone service system and method according to the present invention, a creator/user may install a full-type execution file on his or her PC to use the full-type execution file or install only a plug-in engine on his or her PC to use the plug-in engine. Here, the full-type execution file refers to a single execution file which contains execution environment information, a UI display unit, and a plug-in engine.

If the creator/user installs the full-type execution file on his or her PC, the creator/user can make a phone call over the Internet as soon as clicking on the softphone created by users in the form of the full-type execution file.

On the other hand, if the creator/user installs only the plug-in engine, when the creator/user clicks on the softphone created by users in the form of the plug-in engine, the URL processing unit calls and processes the execution environment information stored in the service system 10 so that the creator/user can make a phone call over the Internet. Since the plug-in engine is included in all softphone created by users, once the creator/user installs the plug-in engine on his or her PC, there is no need for the creator/user to install the plug-in engine again whenever using various types of softphone created by users.

Since the full-type execution file includes all information required to configure and execute the softphone created by users, its size may be large. However, when the full-type execution file is used, there is no need to call the execution environment information. Therefore, the softphone created by users can be quickly executed and used. On the other hand, when the plug-in engine is used, it may take a rather long time to call and process the execution environment information. However, due to the small file size, efficient file transmission is possible.

The Internet phone service system for creating a softphone created by users according to the present invention is configured as follows. The Internet phone service system by using softphone created by users according to the present invention includes the service system 10, a creator, and a user. The service system 10 creates a softphone created by users based on information input through a webpage and connects calls made over the Internet by using the softphone created by users. The creator requests the creation of the softphone created by users by inputting the information, which is required to create the softphone created by users, to the service system 10 and, after the softphone created by users is created, downloads the created softphone created by users in the form of an execution file or inserts a URL code into a webpage as a link to the created-user created softphone. The user uses the created softphone created by users in the form of an execution file in a PC environment or clicks on the URL code, which is inserted into the webpage, to make phone calls over the Internet.

Referring to FIG. 2, the service system 10 includes a web server 11, a generation server 13, a database (DB) 15, a storage server 14, and a telephony system 17. The web server 11 provides webpages 12 through which a creator can input various information required to create a softphone created by users. The generation server 13 creates a softphone created by users based on the information input through the webpages 12. The DB 15 stores the information input by the creator through the webpages 12 and information that is set when the generation server 13 creates the softphone created by users, that is, execution environment information which includes all information required to configure and execute the softphone created by users. The storage server 14 stores an execution file of the softphone created by users created by the generation server 13. The telephony system 17 supports phone calls made over the Internet by using the softphone created by users. Location information of the execution file stored in the storage server 14 is also included in the execution environment information.

Specifically, the web server 11 provides the webpages 12 which include a creation webpage and a management webpage. The creation webpage is used by a creator to input information required to create a softphone created by users. The management webpage provides a URL code, which uses execution environment information of the softphone created by users as a resource, to enable a user to download the softphone created by users to his or her PC in the form of an execution file or to use the softphone created by users on a webpage. In addition, the management webpage is used to modify the softphone created by users after being created. The creation and management webpages may all be provided as template pages.

The service system 10 according to the present invention further includes a plug-in download server 16 which provides a plug-in engine of a softphone created by users.

The Internet phone service system according to the present invention generates the webpages 12 for creating and managing a softphone created by users in the form of template pages. Therefore, the Internet phone service system may include a plurality of web service systems 20, which provide creation and management webpages 22 in the form of template pages, in addition to the service system 10. That is, a template page can be easily inserted into a specified webpage of a specified website. Since the creation and management webpages 22 are generated in the form of template pages, the service system 10 can easily provide the creation and management webpages 22 to each of the web service systems 20, i.e., portal service providers such as Google and Yahoo, without requiring an additional system for a corresponding service or modifying an existing system.

As described above, the service system 10 may provide the creation and management webpages 22, which are in the form of the template pages, to the web service systems 20 and provide a softphone created by users service to users who access the web service systems 20. In addition, the service system 10 may share profits from the softphone created by users service with the web service systems 20. Therefore, the service system 10 can easily promote the softphone created by users service through the web service systems 20 and thus attract more users. Also, the web service systems 20 can expect additional profits without developing additional systems.

The process of creating a user-created softphone by using the Internet phone service system is as follows.

Referring to FIG. 3, a creator accesses the webpages 12 or 22 provided by the service system 10 or the web service systems 20 and inputs various information required to create a softphone created by users as follows.

First of all, the creator sets a file name of a softphone created by users to be created (operation S110) and sets the destination of calls or message sent by using the softphone created by users. That is, the destination of phone calls and SMS messages sent by using the softphone created by users may be limited to the creator so that a user of the softphone created by users can make phone calls or send SMS messages only to the creator (operation S120). In this case, the creator inputs his or her phone number (operation S122). Here, the creator may set his or her phone number, i.e., the called number, to be shown on an external display of the softphone created by users. Alternatively, the creator may set a specified message to be shown on the external display of the softphone created by users in order to prevent his or her telephone number from being indiscreetly disclosed.

The destination of phone calls and SMS messages may not be limited so that the user of the softphone created by users can make phone calls or send SMS messages to anyone (operation S124). In this case, the creator can also use the softphone created by users created by himself or herself.

The creator may select a function of the softphone created by users (operation S130). That is, the creator selects at least one of a call function and an SMS function of the softphone created by users. For example, the creator may set the softphone created by users such that the user can use only the call function, only the SMS function, or both of the call function and the SMS function by using the softphone created by users.

When receiving a call from the softphone created by users, the creator may input a calling number which is shown as a phone number of the softphone created by users (operation S132). This is to distinguish the softphone created by users from other softphone created by users, which were created by the creator, based on the calling number when the creator receives a call from the softphone created by users.

The creator may set a password in order to limit the use of the softphone created by users (operation S134). If the creator sets the password of the softphone created by users, the user must enter the password in the process of executing the softphone created by users to use the softphone created by users. The reason why the creator sets the password is to prevent the softphone created by users from being used by unwanted users or allow only those who know the password of the softphone created by users to use the softphone created by users that can be exposed to many and unspecified persons through the Web. The creator may set the calling number of the softphone created by users as the password of the softphone created by users or input a new password. Setting the password is optional. Thus, the creator may choose to omit the process of setting the password.

Referring to FIGS. 5 and 6, the creator may set the configuration of the external display of the softphone created by users that appears on a PC screen (operation S136). The external display of the softphone created by users includes a body which forms the exterior of the softphone created by users, a flashcon which adds interest and fun, an image frame into which a photograph or image is inserted, and a message frame into which a message that the creator intends to send to the user is inserted. The creator sets a photograph or image, which is to be inserted into the image frame, and inputs a message which is to be inserted into the message frame.

The creator may link a specified webpage to at least one of the components of the external display of the softphone created by users. For example, the creator may link his or her homepage to the flashcon. In this case, if the user clicks on the flashcon while using the softphone created by users, the user may immediately move to the creator's homepage.

The present invention may provide an environment in which the creator can configure the external display of the softphone created by users to include more various components by using diverse static or dynamic images, moving images, music and the like in addition to the flashcon, the image frame and the message frame defined above. The reason why the external display of the softphone created by users can include various components is that a UI display unit of the softphone created by users is formed as a flash.

Finally, the creator pays for the cost of creating the softphone created by users and charges the softphone created by users with a predetermined amount of money (operation S138).

The above operations are performed by the creator to input the information, which is required to create the softphone created by users, through the creation webpage, and the service system 10 creates the softphone created by users based on the input information.

That is, the information input by the creator to create the softphone created by users is stored in the DB 15 (operation S140), and the generation server 13 creates the softphone created by users based on the input information (operation S142).

In addition, various information required to execute the created softphone created by users is stored in the DB 15 (operation S144), and an execution file of the softphone created by users created by the generation server 13 is stored in the storage server 14, thereby completing the creation of the softphone created by users (operation S150).

The process of modifying the softphone created by users created as described above is as follows.

Referring to FIG. 4, the creator accesses the webpages 12 or 22 provided by the service system 10 or the web service systems 20, retrieves creation information of the softphone created by users, that is, the information which was input by the creator to create the softphone created by users, from the DB 15, and changes the retrieved information to modify the softphone created by users (operation S200).

The creator may change the filename of the softphone created by users (operation S210) or set a new destination of calls from the softphone created by users (operation S220). The creator may change the called number, the calling number or the password of the softphone created by users (operations S230 through 250).

In addition, the creator may change the configuration of the external display of the softphone created by users (operation S260). That is, the creator may change the body, flashcon, image frame and message frame of the softphone created by users or may change the image and the message inserted into the image frame and the message frame, respectively.

The creator may recharge the softphone created by users with a predetermined amount of amount (operation S270). When the creator recharges the softphone created by users with a predetermined amount of money or purchases a fee-charging component to be used for the external display of the softphone created by users, the creator has to pay the predetermined amount of money or pay for the purchase (operation S272).

Based on modification information of the softphone created by users input by the creator through the management webpage 12 or 22, the execution environment information of the softphone created by users stored in the DB 15 is updated (operation S280), and the execution file of the softphone created by users, which is stored in the storage server 14, is also updated (operation S290). When the execution environment information is updated, the version information of the softphone created by users is also changed.

Even after the softphone created by users created and distributed by the creator is modified, the URL processing unit calls and processes the updated execution environment information when the user executes the modified softphone created by users. Therefore, there is no need for the creator to distribute the modified softphone created by users in an additional process. In addition, the user can always use the modified, that, is, updated, softphone created by users without going through an additional process for using the modified softphone created by users.

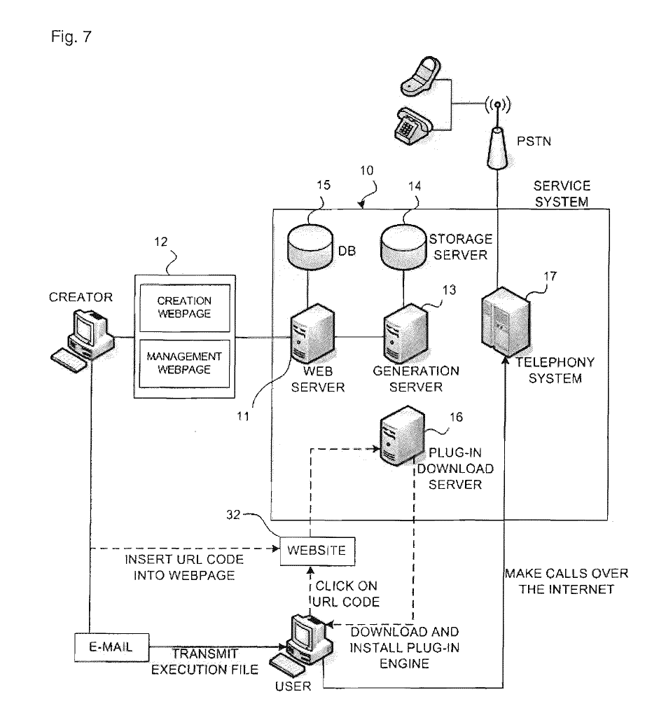

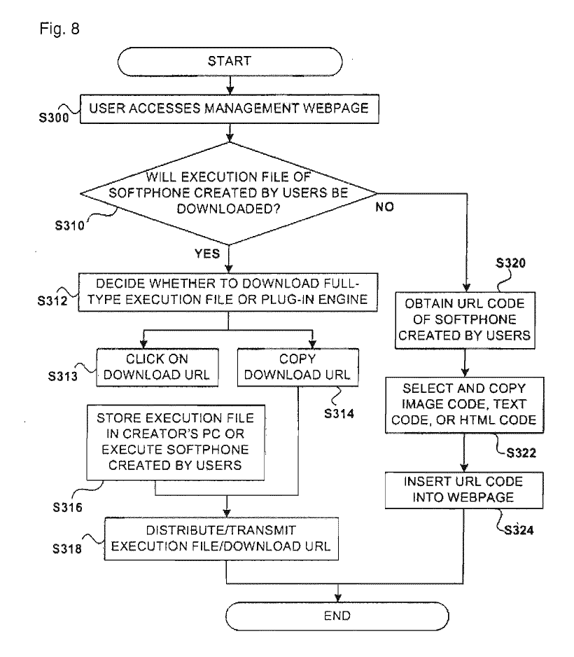

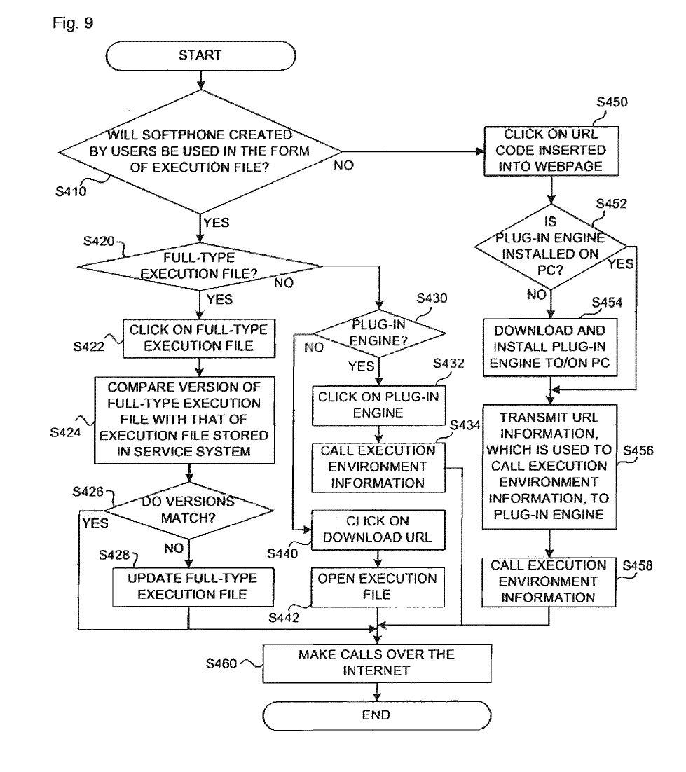

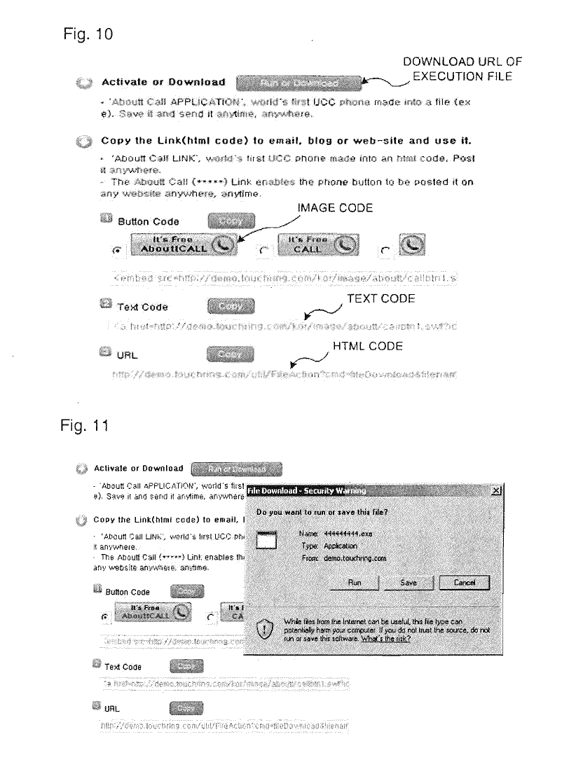

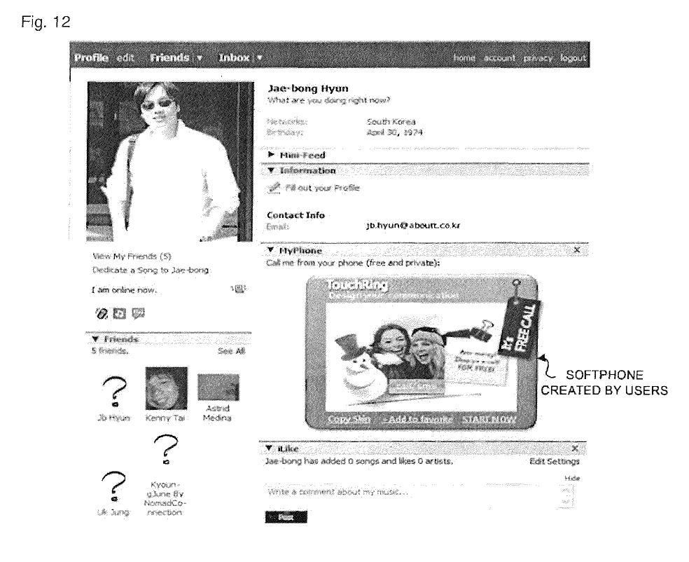

FIG. 7 is a block diagram of the Internet phone service system for obtaining and using a softphone created by users according to the present invention. FIGS. 8 and 9 are flowcharts respectively illustrating processes of obtaining and using a softphone created by users according to the present invention. FIGS. 10 and 11 are screens showing the process of obtaining a softphone created by users according to the present invention. FIG. 12 shows an example of a webpage into which a softphone created by users according to the present invention has been inserted.

Referring to FIGS. 7 and 8, a creator downloads a softphone created by users from the service system 10 as follows.

The creator accesses the management webpage provided by the service system 10 or the web service systems 20 and obtains a softphone created by users created by himself or herself (operation S300). Here, the creator may download the softphone created by users in the form of an execution file as shown in FIG. 10 (operation S310) or obtain a URL code which uses execution environment information of the softphone created by users as a resource (operation S320).

A case where the creator downloads the softphone created by users in the form of an execution file (operation S310) will first be described. In this case, the creator may download the execution file through the management webpage.

The creator may download a full-type execution file which includes all of the execution environment information, a UI display unit and a plug-in engine of the softphone created by users or download only the plug-in engine from the plug-in download server 16 (operation S312). The URL processing unit of each execution file includes URL information used to call the execution environment information of a corresponding softphone created by users. In addition, the service system 10 itself may be set to provide any one of the full-type execution file and the plug-in engine.

When the creator decides to download the execution file of the softphone created by users, a download URL for opening the execution file is provided on the management webpage as shown in FIG. 11. Here, the download URL uses one of the full-type execution file and the plug-in engine as a resource. When the creator clicks on the download URL, a dialog window pops up. Here, the creator may click on “Save” to download the execution file to his or her PC or click on “Run” to open the execution file and execute the softphone created by users immediately (operation S313). Alternatively, the creator may not click on the download URL and just copy the download URL (operation S314).

The creator may upload the execution file stored in his or her PC or the obtained download URL to a specified website 32 in order to allow users to download the execution file or the download URL or may attach the execution file or the download URL to e-mails or messengers and send them to the users (operation S318).

Next, a case where the creator obtains the URL code which uses the execution environment information of the user-created phone as a resource (operation S320) will be described. The URL code obtained by the creator may be any one of an image code, a text code, and a hypertext markup language (HTML) code (operation S322). The URL code may be obtained by copying the URL code provided on the management webpage.

The URL code includes URL information used to call the execution environment information which is stored in the DB 15 of the service system 10 and which contains all information required to configure and execute the execution file. When the URL code is implemented as the image or text code, it may be linked to a predetermined image or text.

The creator may insert the URL code or a hyperlink into webpages (e-mails, blogs, shopping mall pages, a homepage, and the like) and documents provided by the website 32 (operation S324).

In order to use the softphone created by users through the URL code, a user must install the plug-in engine on his or her PC. The plug-in engine does not contain the URL information which uses the execution environment information of the softphone created by users as a resource.

When the user clicks on the URL code, the URL code checks whether the plug-in engine is installed on the user's PC. If the plug-in engine is not installed on the user's PC, it is downloaded from the plug-in download server 16 of the service system 10 to the user's PC and installed on the user's PC. Once the plug-in engine is installed on the user's PC in this way, it can be used regardless of types of softphone created by users.

When the user clicks on the URL code, the URL code transmits the URL information, which is used to call the execution environment information of the softphone created by users, to the URL processing unit of the plug-in engine installed on the user's PC. The URL processing unit calls and processes the execution environment information based on the received URL information, thereby executing the softphone created by users.

As described above, a user may execute a softphone created by users by obtaining a URL code instead of downloading a full-type execution file. Specifically, the user may install a plug-in engine, which is commonly used by all users, on his or her PC only. Then, if the user clicks on the URL code, URL information which is included in the URL code and uses execution environment information of the softphone created by users as a resource may be transmitted to the plug-in engine. Consequently, the softphone created by users may be executed. When the softphone created by users is executed as described above, only the execution environment information of the softphone created by users is required additionally. Thus, the quick transmission and execution of the softphone created by users are possible.

Referring to FIGS. 7 and 9, a softphone created by users according to the present invention is used as follows.

First of all, a case where a user uses a softphone created by users made into an execution file (operation S410) will be described. In this case, if the user is a creator of the softphone created by users, the creator may use the execution file that was downloaded to his or her PC. If the user is not the creator of the softphone created by users, the user may receive the execution file from the creator through an e-mail as indicated by a solid line in FIG. 7.

When the user decides to use the softphone created by users in the form of a full-type execution file (operation S420) and thus clicks on the full-type execution file (operation S422), a URL processing unit of the full-type execution file compares the version of execution environment information included in the full-type execution file with that of execution environment information stored in the DB 15 of the service system 10 (operation S424). If the two versions match (operation S426), the full-type execution file is executed immediately, and thus a phone call can be made over the Internet (operation S460).

If the versions do not match (operation S426), the version of the execution environment information of the full-type execution file installed on the user's PC is updated to that of the execution environment information stored in the DB 15 of the service system 10 (operation S428). As the full-type execution file is executed, a phone call can be made over the Internet (operation S460).

When the user decides to use the softphone created by users in the form of a plug-in engine (operation S430) and thus clicks on the plug-in engine (operation S432), a URL processing unit of the plug-in engine calls the execution environment information of the softphone created by users from the DB 15 of the service system 10 based on URL information recorded therein and processes the execution environment information (operation S434), so that the user can make a phone call over the Internet by using the softphone created by users (operation S460).

If the user decides to use the softphone created by users in the form of a download URL which uses the execution file of the softphone created by users as a resource (operation S440), the user may click on the download URL to immediately execute the execution file or download the download URL to execute the execution file later (operation S442). Here, if the resource of the download URL is the full-type execution file, the softphone created by users is immediately executed. If the resource of the download URL is the plug-in engine, the softphone created by users is executed after the execution environment information of the softphone created by users is called from the service system 10 and then processed. When the download URL is used as described above, the execution file is downloaded from the service system 10 and then executed. Therefore, no additional process is required to update the execution file.

Next, a case where the user uses a URL code which uses the execution environment information of the softphone created by users as a resource will be described. That is, as indicated by a dotted line in FIG. 7, if the creator inserts the URL code, which uses the execution environment information of the softphone created by users as a resource, into a webpage provided by the website 32, the user may access the webpage and click on the URL code on the webpage to use the softphone created by users, which will now be described in more detail.

If the user clicks on the URL code inserted into the webpage (operation S450), it is checked whether a plug-in engine is installed on the user's PC (operation S452). If the plug-in engine is not installed on the user's PC (operation S452), the URL code downloads the plug-in engine from the plug-in download server 16 of the service system 10 to the user's PC and installs the downloaded plug-in engine on the user's PC (operation S454).

In addition, the URL code transmits URL information, which is used to call the execution environment information of the softphone created by users, to a URL processing unit of the plug-in engine installed on the user's PC (operation S456). After receiving the URL information, the plug-in engine calls the execution environment information of the softphone created by users from the service system 10 based on the URL information and processes the execution environment information (operation S458). Accordingly, the softphone created by users is executed (operation S460).

If a password is set in the execution file or the URL code of the softphone created by users, when the user opens the execution file or the URL code, a message window asking the user to input the password appears, and the execution file or the URL code is executed only after the user inputs a correct password.

When the user executes the execution file or the URL code, the external display of the softphone created by users, which is configured by using information included in the execution environment information of the softphone created by users, appears on the user's PC as shown in FIGS. 5 and 6. Since the execution environment information of the softphone created by users includes all information required to use the softphone created by users, such as login information of the softphone created by users and payment information for phone calls and SMS messages, the user need not go through subscription and login processes.

Ultimately, the user can make phone calls over the Internet by using the softphone created by users. When the user cannot make phone calls since the user does not have, for example, a headset, the user can send SMS messages by using the softphone created by users.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

As described above, in an Internet phone service system and method by using softphone created by users according to the present invention, a creator can create a softphone created by users by using a service system according to the present invention. That is, the creator can easily and quickly create a softphone created by users that suits his or her taste by inputting various setting information (e.g., call setting information and UI setting information) to the service system. Then, the creator can transmit the created softphone created by users directly to users in the form of an execution file by using e-mails, messageers, and the like. In addition, the creator can transmit the created softphone created by users to users by using other various methods, such as by inserting a web link to the created softphone created by users into webpages or inserting a hyperlink to the softphone created by users into documents. Also, the creator himself or herself can use the created softphone created by users.

According to the present invention, the creator can create various forms of softphone created by users having various functions that meet the creator's requirements and purposes by setting the usage range and functions of each softphone created by users when creating each softphone created by users.

According to the present invention, since users use a softphone created by users charged with a predetermined amount of money by the creator, phone calls that the users make over the Internet by using the softphone created by users correspond to collect calls.

According to the present invention, users can use a softphone created by users without going through a subscription process or a login process of entering an ID and a password.

According to the present invention, various information required to execute a softphone created by users is stored in the service system. Therefore, the creator can easily modify the softphone created by users. After modifying the softphone created by users, the creator need not distribute the modified softphone created by users in an additional process to reflect modifications. Accordingly, users can use the modified softphone created by users without going through an additional process.

According to the present invention, the creator can limit the usage range of a softphone created by users to himself or herself and allow a plurality of users to use the softphone created by users. Therefore, the creator can economically carry out sales/marketing/advertising activities to the users until an amount of money, with which the softphone created by users is charged, is used up.

According to the present invention, the creator can configure an external display of a softphone created by users, which is to be shown on users' PCs, by using various photographs, icons, messages and the like. Therefore, the creator can efficiently carry out sales/marketing/advertising activities to the users in various ways.

1. An Internet phone service system by using softphone created by users, the Internet phone service system comprising:
a service system creating a softphone created by users based on information input through a webpage and connecting calls made over the Internet by using the softphone created by users;
a creator requesting the creation of the softphone created by users by inputting the information to the service system and, after the softphone created by users is created, downloading the softphone created by users in the form of an execution file or inserting a universal resource locator (URL) code into a webpage as a link to the softphone created by users;
a user using the softphone created by users in the form of the execution file in a personal computer (PC) environment or clicking on the URL code, which is inserted into the webpage, to make phone calls over the Internet.

2. The Internet phone service system of claim 1, wherein the service system comprises:
a web server providing a creation webpage through which information required to create a softphone created by users is input and a management webpage which is used to modify a softphone created by users after being created and provides a URL code, which uses execution environment information of the softphone created by users as a resource, to enable the user to download the softphone created by users to the user's PC in the form of the execution file or to use the softphone created by users on a webpage;
a generation service creating a softphone created by users based on the information input through the creation and management webpages;
a database (DB) storing execution environment information required to configure and execute the softphone created by users;
a storage server storing an execution file of the softphone created by users; and
a telephony system supporting phone calls made over the Internet by using the softphone created by users.

3. The Internet phone service system of claim 2, wherein the service system further comprises a plug-in download server which provides a plug-in engine.

4. The Internet phone service system of claim 1, further comprising a web service system providing creation and management webpages in the form of template pages and transmitting creation information and modification information of a softphone created by users, which are input through the creation and management webpages, respectively, to the service system.

5. The Internet phone service system of claim 1, wherein the softphone created by users comprises:
a user interface (UI) display unit forming an external display of the softphone created by users;
execution environment information comprising configuration and execution information of the softphone created by users; and
a plug-in engine comprising a URL processing unit which calls and processes a URL that uses the execution environment information as a resource, a softphone stack module which connects a phone call over the Internet based on call information input through the UI display unit, and a platform which links the UI display unit to the softphone stack module.

6. The Internet phone service system of claim 6, wherein the UI display unit is created as a flash.

7. The Internet phone service system of claim 5, wherein, if the creator decides to download the softphone created by users in the form of the execution file, the creator downloads the plug-in engine or a full-type execution file which contains the UI display unit, the execution environment information, and the plug-in engine.

8. The Internet phone service system of claim 7, wherein, if the user decides to use the softphone created by users in the form of a full-type execution file, a version of execution environment information included in the full-type execution file is compared with that of execution environment information stored in the service system, and the version of the execution environment information of the full-type execution file is updated to that of the execution environment information stored in the service system.

9. The Internet phone service system of claim 5, wherein, when the user clicks on the URL code inserted into the webpage to use the softphone created by users, it is checked whether the plug-in engine is installed on the user's PC, the plug-in engine is downloaded from the service system to the user's PC and installed on the user's PC if the plug-in engine is not installed on the user's PC, the URL code transmits URL information, which is used to call the execution environment information of the softphone created by users, to the plug-in engine installed on the user's PC, and the softphone created by users is executed after the plug-in engine calls and processes the execution environment information of the softphone created by users based on the URL information.

10. An Internet phone service method by using softphone created by users, the method comprising:
a creator inputting information required to create a softphone created by users in the form of an execution file to a service system;
the service system creating the softphone created by users based on the information input by the creator;
the creator downloading the created softphone created by users in the form of the execution file or inserting a URL code into a webpage as a link to the created softphone created by users; and
a user using the softphone created by users in a PC environment in the form of the execution file or clicks on the URL code, which is inserted into the webpage, to make phone calls over the Internet.

11. The method of claim 10, wherein the inputting of the information required to create the softphone created by users by the creator comprises:
setting a file name of the softphone created by users;
deciding to limit a destination of calls and messages from the softphone created by users to the creator or deciding not to limit the destination;
inputting a phone number of the creator when deciding to limit the destination to the creator;
inputting a calling number which is shown on the softphone created by users;
setting the display configuration of the softphone created by users which appears on a PC screen; and
paying for the cost of creating the softphone created by users and charging the softphone created by users with a predetermined amount of money.

12. The method of claim 10, further comprising setting a password to limit the use of the softphone created by users.

13. The method of claim 10, further comprising:
the creator inputting modification information of the softphone created by users to the service system; and
updating the softphone created by users stored in the service system based on the modification information input by the creator.

14. The method of claim 10, wherein the softphone created by users comprises:
a UI display unit forming an external display of the softphone created by users;
execution environment information comprising configuration and execution information of the softphone created by users; and
a plug-in engine comprising a URL processing unit which calls and processes a URL that uses the execution environment information as a resource, a softphone stack module which connects a phone call over the Internet based on call information input through the UI display unit, and a platform which links the UI display unit to the softphone stack module.

15. The method of claim 14, further comprising, if the creator decides to download the softphone created by users in the form of the execution file, deciding whether to download the plug-in engine or a full-type execution file which contains the UI display unit, the execution environment information, and the plug-in engine.

16. The method of claim 15, further comprising, if the user decides to use the softphone created by users in the form of the full-type execution file, comparing a version of execution environment information included in the full-type execution file with that of execution environment information stored in the service system and updating the version of the execution environment information of the full-type execution file to that of the execution environment information stored in the service system.

17. The method of claim 15, further comprising, if the user decides to use the softphone created by users in the form of the plug-in engine, calling the execution environment information of the softphone created by users based on URL information which was input to the URL processing unit, processing the execution environment information, and executing the softphone created by users.

18. The method of claim 14, further comprising, when the user clicks on the URL code inserted into the webpage to use the softphone created by users:
checking whether the plug-in engine is installed on the user's PC, downloading the plug-in engine from the service system to the user's PC if the plug-in engine is not installed on the user's PC, and installing the downloaded plug-in engine on the user's PC;
transmitting the URL information, which is used to call the execution environment information of the softphone created by users, to the plug-in engine installed on the user's PC by using the URL code; and
executing the softphone created by users after the plug-in engine calls and processes the execution environment information of the softphone created by users based on the URL information.
